(19) United States
(12) Patent Application Publication
(10) Pub. No.: US 2016/0021356 A1
(43) Pub. Date: Jan. 21, 2016

(54) Method and a System of a Portable Device for Recording 3D Images for 3d Video and Playing 3D Games

(71) Applicant: Maurice Moshe Ernst, Jerusalem (IL)

(72) Inventor: Maurice Moshe Ernst, Jerusalem (IL)

(21) Appl. No.: 14/333,523

(22) Filed: Jul. 17, 2014

(51) Int. Cl. H04N 13/02; H04N 5/232

(52) U.S. Cl. CPC H04N 13/0207; H04N 5/23212

(57) ABSTRACT

The present invention utilises a portable device for recording 3D images of stationary or moving objects. The main object of the present invention is to record 2D image by capturing a single image of the object, using the focusing system of the imaging device to aim transmitting modulated emission or projecting pattern, sensing the reflection from the object, measuring the angle between the transmission (or projection) and imaging, and using the information to create a 3D image.

### BACKGROUND

The present invention relates to the field of 3D imaging. More specifically, the present invention relates to a handheld portable device for recording 3D images.

3D images are useful in computer games and video projections. There are several methods to record 3D images, but all of them use at least two imaging devices. One of these methods is disclosed in the USPTO publications 2011/0074926 of Khan et al. that disclosed a system and method for generating 3D video from a plurality of 2D video streams. This application has as yet not granted, but still provides the method with a plurality of video streams.

The present invention provides a method and device for recording 3D images, using a single imaging device.

### SUMMARY OF THE INVENTION

The present invention is a method and a portable device for recording 3D images of stationary or moving objects. The main object of the present invention is to record 2D image by capturing a single image of the object, using the focusing system of the imaging device to aim transmitting modulated emission or projecting pattern, sensing the reflection from the object, measuring the angle between the transmission (or projection) and imaging and using the information to create a 3D image. This is especially advantageous as current 3d systems for moving subjects create blurred inaccurate 3d reconstruction, or use multiple cameras situated around the subjects imaged. This invention of focusing the pattern and knowing the angle enables accurate 3d reconstruction using even one single portable device. Alternatively, recognized features on the scene or any reflection from the scene can be used instead of the transmission or projection.

According to a preferred embodiment, a method is provided for recording 3D images using a handheld portable device, this method comprised of the following steps: (a) focusing imaging device, using a focus system, on an object to be imaged; (b) using a location system and registering the location coordinates of the imaging device at the time of taking the image (c) transmitting modulated emission using transmission medium—sonic, ultrasonic, electromagnetic or any other emission—or projecting a pattern, using a pattern generator, on the object, using information from the focus system to aim the transmission or projection; (d) measuring the angle of the transmission or projection relative to the capturing device; (e) capturing, using the imaging device with focus system, an image of the object with matching information with the transmitted or projected information; (f) sensing the reflection of the transmission or projection from the object and comparing the reflection with the transmitted emission or projected pattern information in order to identify deformations; (g) storing the imaging data contains: the transmitted emission, the pattern, the deformations, the captured image, the matching information and the projection or transmission angles; and (h) processing the data in order to reconstruct a 3D image.

According to another preferred embodiment the method is provided wherein the measuring is done of the imaging angle and the transmission or projection angles, wherein both angles are measured relative to the same point and wherein both angles are stored and used for the processing.

According to another preferred embodiment the method is provided wherein further using a locator, for example using a gyroscopic based system, to define the location of each image relative to a starting point or to any coordinate system or GPS system. Moreover the locator can be used for tracking the imaging frame where the imaging device and the pattern generator are moved.

According to another preferred embodiment the method is provided wherein the transmitted emission can be a visible emission, sound, ultrasound, electromagnetic or any other emission.

According to another preferred embodiment the method is provided wherein the 3D reconstruction is processed by using a data of a single image, or by using a plurality of images in order to enlarge the 3D reconstruction features, or made by combining a plurality of 3D reconstructions. The method enables 3d games (there are two different scenarios—combining images for more data with little or no movement , and following movements in 3d), and 3d inter reactive programs.

According to another preferred embodiment the method is provided wherein the method is used to capture a plurality of 3D images in order to create a 3D video.

According to another preferred embodiment the method is provided, wherein instead of transmitting or projecting, using at least one of the followings: recognized features in the scene, any reflection received from the scene or any transmission received from the scene.

According to another aspect of the present invention, a handheld portable system for recording 3D images is provided. This system is comprised of: (a) an imaging device, with a manual and automatic focusing system, for imaging an object; (b) a transmission medium or pattern generator capable to transmit modulated emission or to project a pattern pulse with matching information, on the object, wherein the medium or the generator uses the focus system information to aim the emission or projection on the object; (c) a suitable sensor for sensing the reflection of the transmission or projection from the object; (d) an angle measuring unit that measures the angle of the transmission or projection relative to the imaging device; (e) a comparing unit for comparing the projection or transmission with the reflection in order to identify deformations; (f) a storage memory for storing the imaging data contains: the transmitted emission, the pattern, the deformations, the captured image, the matching information and the projection or transmission angles; and (g) a processing unit for processing the data in order to reconstruct a 3D image.

According to another preferred embodiment the system is provided wherein the angle of the imaging is changeable and the measuring unit measures both the imaging angle and the transmitting or projecting angle relative to same reference or relative to each other.

According to another preferred embodiment the system is provided wherein it further includes a locator or GPS system to define the location of each image relative to a starting point or to any coordination system. Moreover the locator or GPS can be used for tracking the imaging frame where the imaging device and the transmission medium or the projector are moving.

According to yet another preferred embodiment the system is provided wherein the transmission can be of a visible transmission, sound, ultrasound, electromagnetic or any other transmission.

According to another aspect of the present invention, the system is provided wherein the system further includes the capability to use, instead of transmitting or projecting, at least one of the followings: recognized features in the scene, any reflection received from the scene or any transmission received from the scene, in order to reconstruct 3D image.

### BRIEF DESCRIPTION OF THE DRAWING

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the FIGURE:

FIG. 1 illustrates a block diagram of the system, according to the present invention.

### DETAILED DESCRIPTION OF THE DRAWING

The present invention is a method and a portable device for recording 3D images.

The principles and operation of the method and the device according to the present invention may be better understood with reference to the drawing and the accompanying description.

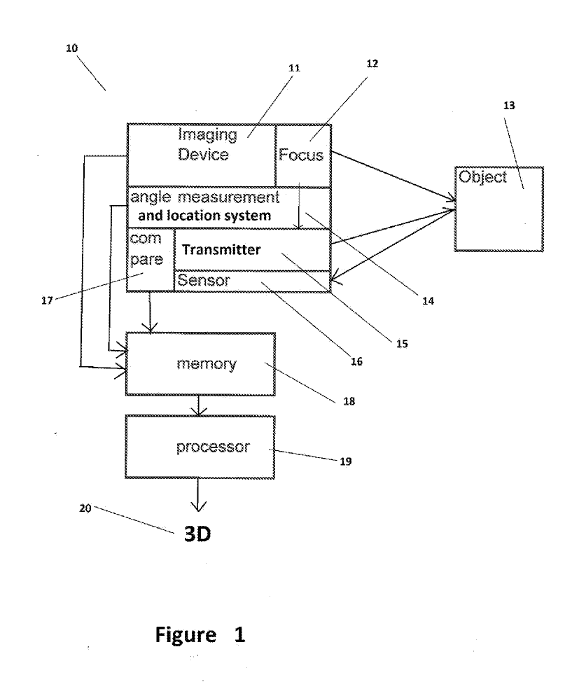

FIG. 1 illustrates a block diagram of the system, according to the present invention. The system 10 is comprised of an imaging device 11 with a focus system 12, using the focus system 12 to focus the objet 13 that is going to be imaged. The transmitter 15 receives the focusing information from the focus system 12 and use it to aim the transmission on the object 13.

When the imaging device 11 and the transmitter 15 are both aimed on the object 13, the angle measuring and location unit 14 measures the angle between the imaging angle and the transmitting angle and registers the location of the imaging device at time of imaging. The capturing and the transmitting are synchronized to be at the same time. While the image is captured by the imaging device 11 the transmitter 15 transmits modulated emission, which can be of any kind of emission, on the object 13. The sensor 16 that is suitable for the king of emission, senses the transmission's reflection and the compare unit 17 receives the transmitted information and the sensed information and compares them to identify deformations from which 3D information can be calculated. The memory 18 stores the whole information that is received; the object's image, the measured angle and the deformations. The processor 19 uses the information to create a 3D image 20.

1. A method for recording 3D images using a handheld portable device, said method comprised of:
Focusing imaging device, using a focus system, on an object to be imaged;
Using a location system and registering the location coordinates of said imaging device at the time of taking an image;
transmitting modulated emission using transmission medium—sonic, ultrasonic, electromagnetic or any other emission—or projecting a pattern, using a pattern generator, on said object, using information from said focus system to aim said transmission or projection;
measuring the angle of said transmission or projection relative to said imaging device;
capturing, using said imaging device, at least one image of said object with matching information with said transmitted or projected information;
sensing the reflection of said transmission or projection from said object and comparing said reflection with said transmitted emission or projected pattern information in order to identify deformations;
storing the image-data contains: said transmitted emission, said recognizing features on the image or said pattern, said deformations, said captured image, said matching information and said projection or transmission angles; and
processing said data in order to reconstruct a 3D image.

2. The method of claim 1, wherein said measuring is done of said imaging angle and said transmission or projection angles, wherein both angles are measured relative to the same point and wherein both angles are stored and used for said processing;

3. The method of claim 1, wherein said location system is a GPS system for registering the location coordinates of said imaging device at the time of taking the image.

4. The method of claim 1, wherein said location system is used for tracking the imaging frame where said imaging device and said pattern generator are moved.

5. The method of claim 1, wherein said transmitted emission can be a visible emission, sound, ultrasound, electromagnetic or any other emission.

6. The method of claim 1, wherein said 3D reconstruction is processed by using a data of a single image.

7. The method of claim 1, wherein said 3d reconstruction is processed by using data of a plurality of images in order to enlarge the 3D reconstruction features.

8. The method of claim 1 wherein said 3D reconstruction is made by combining a plurality of 3D reconstructions.

9. The method of claim 1 wherein said data is used to enable 3d games and 3d interactive programs.

10. The method of claim 1, wherein said method is used to capture a plurality of 3D images in order to create a 3D video.

11. The method of claim 1, wherein instead of transmitting or projecting, using at least one of the followings: recognized features in the scene, any reflection received from the scene or any transmission received from the scene.

12. A handheld portable system for recording 3D images, said system comprised of:
an imaging device, with a manual and/or automatic focusing system, location system and angle measuring system, for imaging an object;
a transmission medium or pattern generator capable to transmit modulated emission or to project a pattern pulse with matching information, on said object, wherein said medium or said generator uses said focus system information to aim said emission or projection on said object;
a sensor for sensing the reflection of said transmission or projection from said object;
an angle measuring unit that measures the angle of said transmission or projection relative to said imaging device;
a comparing unit for comparing said projection or transmission with said reflection or recognized features on the image, in order to identify deformations;
a memory storage for storing the image-data contains: said transmitted emission, said pattern, said deformations, said captured image, said matching information, said projection or transmission angles; and
a processing unit for processing said data in order to reconstruct a 3D image.

13. The system of claim 12 wherein the angle of said imaging is changeable and said measuring unit measures both said imaging angle and said transmitting or projecting angle relative to same reference or relative to each other.

14. The system of claim 12, further includes a location system or GPS system to define the location of each image relative to a starting point or to any coordination system.

15. The system of claim 14, wherein said location system or GPS is used for tracking the imaging frame where said imaging device and said transmission medium or sad projector are moving.

16. The system of claim 12, wherein said transmission can be of a visible transmission, sound, ultrasound, electromagnetic or any other transmission.

17. The system of claim 12, further include the capability to use, instead of transmitting or projecting, at least one of the followings: recognized features in the scene, any reflection received from the scene or any transmission received from the scene, in order to reconstruct said 3D image.
